(19) United States
(12) Patent Application Publication
(10) Pub. No.: US 2007/0094015 A1
(43) Pub. Date: Apr. 26, 2007

(54) Audio codec using the Fast Fourier Transform, the partial overlap and a decomposition in two plans based on the energy.

(76) Inventor: GEORGES SAMAKE, PONTAULT COMBAULT (FR)

Correspondence Address: GEORGES SAMAKE, 16, RUE COPERINIC, PONTAULT COMBAULT, 77340, FR

(21) Appl. No.: 11/532,563

(22) Filed: Sep. 18, 2006

(30) Foreign Application Priority Data
Sep. 22, 2005 (FR) 05 09 677
Aug. 3, 2006 (FR) 06 07 091

(51) Int. Cl. G10L 21/00

(52) U.S. Cl. 704/212

(57) ABSTRACT

Audio codec using the Fast Fourier Transform, the partial overlap and a decomposition in two plans based on the energy. The present invention concerns a method of audio compression and decompression, simple, of high quality, not requiring a lot of computations and allowing to obtain very high compression ratios. This codec is optimized for both the voice and the music. The most spread methods nowadays use the Linear Predictive Coding (LPC) in the time domain for the voice and the Modified Discrete Cosine Transform (MDCT) in the frequency domain for the music. The present codec uses the Fast Fourier Transform (FFT). The Fast Fourier Transform buffers are split into a forward plan (composed only of the biggest points) and a backward plan (composed of the most energetic bands). The non null points in the bands are composed only of points not taken into account in the forward plan. For the voice, this codec uses only the magnitudes of the local peaks (without the laterals points) and only the imaginary part in decompression. For the music and all audio signals, it uses the magnitudes and the phases of the points of the forward and backward plans, in compression and in decompression. It can also use only the local peaks with the phases. The edge effects are canceled with the help of a partial overlap method (50% or less) allowing a perfect reconstruction. Efficient methods of coding of magnitudes and phases are used. This codec is intended for all vocal bi-directional communications (voice over IP or mobile phones for instance), for the audio streaming (radios on Internet for instance) as well as for the stocking of audio data (files on hard disk for instance).

The present invention concerns a method of audio compression and decompression, simple, of high quality, not requiring a lot of computations and allowing to obtain very high compression ratios. This codec is optimized for both the voice and the music. This codec is intended for all vocal bi-directional communications (voice over IP or mobile phones for instance), for the audio streaming (radios on Internet for instance) as well as for the stocking of audio data (files on hard disk for instance).

### BACKGROUND OF THE INVENTION

The present invention concerns a method of audio compression and decompression, simple, of high quality, not requiring a lot of computations and allowing to obtain very high compression ratios. This codec is optimized for both the voice and the music.

The most spread methods nowadays use the linear predictive coding (LPC) in the time domain for the voice and the modified discrete cosine transform (MDCT) in the frequency domain for the music.

The present codec uses the Fast Fourier Transform (FFT) for the voice and the music and a decomposition in two plans based on the energy.

Notes:

In the frequency domain, a local peak is a point with a magnitude bigger than that of the points located on the left and on the right (neighboring or lateral points). A point is bigger than other one if its magnitude is bigger. The energy of a band is the sum of the squares of the magnitudes of the valid points which compose it.

The coding of the music is also good for the voice but is less optimized in reason notably of the taking the phase into account which leads to a necessary overlap for the edge effects canceling. That's why we will differentiate two cases each time it is necessary.

With the partial overlap, we will also differentiate two cases: overlap with 50% of overlapping and overlap with less than 50% of overlapping (in general 5%-10%).

Finally, the music works perfectly with only local peaks and phases but there is in general a small quality loss.

In time domain, non compressed samples (PCM) are converted into 16 bits double precision real numbers. The number of channels and the sampling rate are respected.

The frame size (the FFT buffer size) depends on the sampling rate as follows:

8 and 11 kHz, sampling rates lower than or equal to 11 kHz: 256 points per frame.

16 and 22 kHz, sampling rates upper than 11 kHz and lower than or equal to 22 kHz: 512 points per frame.

32, 44 and 48 kHz, sampling rates upper than 22 kHz and lower than or equal to 48 kHz: 1024 points per frame.

96 kHz, sampling rates upper than 48 kHz: 2048 points per frame.

A Fast Fourier Transform is performed on every frame, that leads to the frequency domain. The magnitudes and phases of all points are calculated. All local peaks are determined. The first and last points do not count as local peaks. All points with a magnitude lower than −120 dB (in comparison with the maximum possible magnitude) are set to zero or ignored. Finally, all points with a real frequency out of the space 20 Hz-22050 Hz are set to zero or ignored.

Voice: the phases are ignored. All points which are not local peaks are ignored. We do not take the lateral points into account.

Music: the phases are taken into account. We take all points into account in the general case. We can take only the local peaks into account.

Every frame is split into a forward plan composed of the N biggest points and a backward plan composed of the M most energetic bands. Bands are composed of all points. Those which are already taken into account in the forward plan or which cannot be taken into account are set to zero or ignored. There is a fixed number of points per band.

For instance for a decomposition in 64 bands, there are:

2 points per band with frames of 256 points (128 useful points in the frequency domain, that is the half of points).

4 points per band with frames of 512 points.

8 points per band with frames of 1024 points.

8 points per band with frames of 2048 points (the upper half of points in the frequency domain is not taken into account).

The magnitudes of points are encoded with integer values with an appropriate method and with a desired precision. The lack of big precision for the magnitudes does not lead to big effects on the sound quality. However, a certain precision is needed if there is overlap.

The methods and the precision are not necessarily the same for the forward plan and the backward plan. Two methods of coding of magnitudes are presented: the base-10 logarithm and the base-2 corrected scale which allows to obtain a great precision.

With the usage of base-10 logarithm and a precision of n bits, the magnitudes are encoded with the following expression:

Code=0 for the null or ignored points, otherwise:
Code=(MaximumValue*log10(Magnitude))/log10(MaximumMagnitude).

MaximumValue=maximum value dependent on the precision n(MaximumValue=2ⁿ−1, 255 in 8 bits, 1023 in 10 bits).

MaximumMagnitude=32767 * Number of points per frame.

Magnitude=magnitude of the point.

The number of points per frame is doubled if there is a 50% partial overlap (music). We do not double the number of points per frame if there is a partial overlap less than 50% (music).

With the base-2 corrected scale, the magnitudes are encoded on 4 to 12 bits. The first four bits (least significant bits) contain a division indication (idivision) and other bits (most significant bits) a rest indication (irest). The magnitudes computed in double precision are computed again in 16 bits double precision (by dividing by the half of points per frame). The base-2 corrected scale allows to encode a real number x such as 2^{x} is the most close to the magnitude.

The precise value of x is:
x=log2 (Magnitude)/log2(2)=log10(Magnitude)/log10(2);

The division indication is equal to the integer part of x:
idivision=(int)x;

The rest indication is equal to:
irest=(int)((x−idivision)*MaximumValue);

MaximumValue=maximum value dependent on the precision n.

(MaximumValue=2ⁿ−1, 15 in 4 bits, 63 in 6 bits, 255 in 8 bits).

In decoding, x is given by:
x=(double)idivision+((double)irest/MaximumValue);

and the magnitude is given by:
Magnitude=2^{x};

Contrary to the magnitudes, the positions must be precise, otherwise there is a strong deterioration of the sound quality.

For the forward plan, it is necessary to choose a precision allowing to reach all desired points. For instance, with a sampling rate of 44 kHz, there are 1024 points per frame in the time domain and 512 points to reach in the frequency domain (the last point is ignored). 9 bits of precision without overlap or with an overlap less than 50% is needed, and 10 bits of precision with a 50% overlap is needed. To diminish the number of bits in the coding of the positions, one can use the relative coding (give the difference of the position of a point in comparison with the position of the previous point). This assumes to re-order the chosen points in comparison with the position and to intercalate points of null magnitude if necessary between two too much distant points. One must not exceed the maximum number of points fixed for the forward plan. If some points were not taken into account, it is necessary to take them into account with the backward plan. Because of possible losses if points are too much distant, the relative coding of positions is more suitable for the coding of the voice, if the maximum number of points of the forward plan is not big enough.

But if the maximum number of points of the forward plan is big enough, losses are void or negligible and the benefit in compression ratio is important.

For the backward plan, the positions of the bands are given. Inside a band, the position is not given but all magnitudes (null or not null) are encoded. 6 bits are needed to transmit all positions of bands if there are 64 bands numbered from 0 to 63. They can take 6 bits per position up to ten bands (60 bits maximum) and 64 bits if there are more than ten bands, every bit pointing out the presence or the absence of a band. In that case, bands must be encoded in the order of increasing positions. It is also necessary to encode bands in the order of increasing positions if they implement a decimation so that they are the most closely related possible.

If they take all bands (64 in case there are 64 bands in the backward plan), they do not transmit the positions of bands (gain of 64 bits) and especially they not calculate the energies of bands or order them (according to energy) and re-order them (according to position).

Voice: for the voice, one uses only the magnitudes of the local peaks (without the lateral points) and only the imaginary part in decompression.

During the decompression, before the inverse of the Fast Fourier Transform (inverse FFT), for all points, they set to zero the real part (amplitude of the cosine) and they give to the imaginary part (amplitude of sinus) the value of decoded magnitude. The use of the imaginary part only allows to reduce the edge effects while keeping the quality of the voice. With a limited number of local peaks and bands, there is no audible edge effects.

Music: the music demands many points and/or many bands. The taking the phases into account is necessary to have a good musical timbre but leads to audible edge effects if there is no overlap.

For the edge effects canceling with the music, one uses a method of partial overlap allowing a perfect reconstruction, with 50% or less than 50% of overlapping.

Partial overlap with 50% of overlapping:

The analysis and synthesis window, applied in the time domain before FFT (compression) and after inverse FFT (decompression), is the sinus function:
w(n)=sin((PI/N)*(n+0,5)); for 0<=n<N/2
w(n)=sin((PI/N)*(N−n−0,5)); for N/2 <=n<N

PI=3,141592654 . . .

n varies from 0 to N−1, where N indicates the size of the new FFT buffer.

Note that the 50% overlap leads ton an intermediate doubling of the size of the FFT buffers. In term of compression ratio, it is more interesting to double the internal buffers because the number of points of the forward plan is not proportional to the size of the FFT buffers.

Before application of the analysis window and FFT, every new FFT buffer is constituted for left half of an already used initial buffer and for right half of a not used initial buffer.

After inverse FFT and application of the synthesis window, every left half is added to an previous right half to give the final buffer of the same size as the initial size of buffers.

They advance therefore in input as in output of the initial size of FFT buffers.

The intermediate doubling of the size of the FFT buffers is very costly for the coding of the backward plan. For the backward plan, one can apply a coefficient of reduction between 1 and 2 to reduce the size of bands, the coefficient 1 corresponding to the initial size of bands. In the frequency domain, this is equivalent to neglect the upper frequencies. If they take coefficient 1, they neglect the upper half of frequencies, the real frequencies of the backward plan will be between 20 Hz and 11025 Hz. If they take coefficient 1,5, the real frequencies of the backward plan will be between 20 Hz and 16537 Hz.

Partial overlap with less than 50% of overlapping (in general 5%-10%):

The analysis and synthesis window, applied in the time domain before FFT (compression) and after inverse FFT (decompression), is the following function:
w(n)=sin((PI*(n+0,5))/(2* (N−N1))); for 0<=n<N−N1
w(n)=1; for N−N1<=n<N1
w(n)=sin((PI*(N−n−0,5))/(2*(N−N1))); for N1<=n<N

PI=3,141592654 . . .

n varies from 0 to N−1

N indicates the size of the FFT buffer.

N1 indicates the size of the non covered part of the FFT Buffer.

Before application of the analysis window and FFT, every new FFT buffer is partly constituted left (points 0 to N−N1−1) of an already used initial buffer and partly right (points N−N1 to N−1) of a non used initial buffer.

After inverse FFT and application of the synthesis window, every left part (points 0 to N−N1−1) is added to the end of a previous right part (points N1 to N−1), the right part being taken without change, to give the final buffer of the same size as the initial size of buffers. The end of the right part (points N1 to N−1) of the final buffer will be finished only at the next phase.

They advance therefore in input as in output of the size of the non covered part of FFT buffers (N1).

Note that in that case, they do not apply intermediate doubling of the size of FFT buffers. The application of the coefficients of reduction in the backward plan is however possible since it is a question of neglecting the upper frequencies.

The partial overlap with less than 50% of overlapping allows toobain more higher compression ratios with fewer computations (FFT, energies and sorting), since there is not intermediate doubling of the size of FFT buffers. Besides, they apply no window to the biggest part of the FFT buffer, which is subjected to the least possible practical distortions.

For the forward plan, the coding of phases on 6-8 bits (of which a bit of sign) gives good results. They will use 8 bits by default.

For the backward plan, the coding of phases on 4 bits (of witch a bit of sign) suits. For the backward plan, the coding of phases on a bit of sign gives good results and is much less costly, if there are many points in the forward plan. They will use a bit of sign by default.

The value of phase is given by:
Phase=¦dblphase¦/dblcoeff;

|dblphase¦=absolute value of the phase calculated in double precision.
dblcoeff=PI/MaximumValue.

PI=3,141592654 . . .

MaximumValue=maximum value of the phase (127 in 7 bits).

To reduce the size of data in the bands, one can apply the simple decimation which leads to a light quality loss, or the double decimation which leads to a bigger quality loss. Simple decimation consists in replacing two successive points (a pair of points) with an indicator of one bit (the weaker magnitude is located to the left or to the right) and a point. Simple decimation does not lead to quality loss if there are only local peaks without lateral points because all any points in bands are local peaks preceded or followed by a null point. Double decimation consists in replacing two successive pairs of points with the biggest pair, an indicator of an additional bit (in comparison with simple decimation) being necessary to say if the smallest pair is to the left or to the right. These types of decimation are more particularly suitable for the coding of the voice.

To reduce the size of data in the bands, one can apply the Adaptive Differential Pulse Code Modulation (ADPCM). The coding of bands by ADPCM is more particularly suitable for the coding of the music.

The magnitudes in the backward plan are computed again in 16 signed bits: 15 bits of value (by dividing by the intermediate size of FFT buffers) and a bit of sign (sign of the phase). They apply an ADPCM compression (for instance IMA ADPCM) to have 2, 3, 4 or 5 bits per point (of which a bit of sign).

They can even apply simple decimation and still have good results: in that case there is an indicator of a bit to point out the position of the point of weaker magnitude, a bit of sign and 1, 2, 3 or 4 bits of value. Simple decimation followed by the ADPCM coding gives an average of 1.5/2/2.5 and 3 bits per point.

Note the indexes to use for IMA ADPCM 2, 3, 4 or 5 bits per point:
−1, 2,−1,−1,−1,−1,−1,−1,−1,−1,−1,−1,−1,−1,−1,−1
−1,−1, 2, 4,−1,−1,−1,−1,−1,−1,−1,−1,−1,−1,−1,−1
−1,−1,−1,−1, 2, 4, 6, 8,−1,−1,−1,−1,−1,−1,−1,−1
−1,−1,−1,−1,−1,−1,−1,−1, 2, 4, 6, 8,10,12,14,16

Note also that it is necessary to use and to transmit the first value of the magnitude.

A practical realization can be made by taking a maximum numberNmax of points of the forward plan equals to 256, by taking a maximum numberMmax of bands of the backward plan equals to 64 and by restricting the maximum numberNCHmax of channels to 8. They can give the choice of the 10-base logarithm or the base-2 corrected scale. The bits rate is taken constant. Without an additional lossless compression, the variable bits rate does not lead to a notable reduction of the bits rate.

With overlap (take the phases into account), for the backward plan bands, they take a coefficient of reduction of two (no change) for sampling rates lower than or equal to 11 kHz, a coefficient of reduction of 1.5 for sampling rates upper than 11 kHz and lower or equal to 22 kHz, and a coefficient of reduction of 1 (the upper half of frequencies not taken into account) for sampling rates upper than 22 kHz.

In the case of the music and all audio signals, the taking local peaks only into account is left in choice. It leads to a small quality loss in general, there is no modification of the bits rate but the music is lighter.

Finally, they will give the choice between a 50% partial overlap and a variable partial overlap from 5% to 10%.

If there is no overlap or if there is a 50% partial overlap, the bits rate in kilobits per second (Kbps) is given by the expression:
BitsRate=(Frequency*CompressedSize*8)/(FFTBufferSize*1000);
where:

Frequency=sampling rate.

CompressedSize=number of bytes of the compressed frame.

FFTBufferSize=number of points of the initial FFT buffer.

If there is a partial overlap less than 50%, the bits rate in kilobits per second (Kbps) is given by expression:
BitsRate=(Frequency*CompressedSize*8*Coefficient)/(FFTBufferSize*1000);
where
Coefficient=100/(100−x);
and x=rate of overlap in %.

The number of bytes of the compressed frame takes the possible intermediate doubling of FFT buffers into account (partial 50% overlap).

If there is no overlap or if there is a 50% partial overlap, the compression ratios are given for 16 bits samples in input and calculated by following expression:
CompressionRatio=CompressedSize/(FFTBufferSize*2);

If there is a partial overlap less than 50%:
CompressionRatio=(CompressedSize*Coefficient)/(FFTBufferSize*2);

By default, for the voice, they choose the base-2 corrected scale, they choose for the forward plan 8 local peaks per frame, the precision of magnitudes on 4 bits and the relative coding of positions on 6 bits; they choose 4 bands per frame for the backward plan, the precision of magnitudes on 4 bits and the simple decimation. There are neither phases nor lateral points.

These parameters give a good quality with the following results:

16 kHz: compression ratio 1/53, bits rate 4.7 Kbps per channel.

22 kHz: compression ratio 1/53, bits rate 6.5 Kbps per channel.

If they choose 6 local peaks for the forward plan and always the simple decimation for the backward plan, they have a good quality with the following results:

8 kHz: compression ratio 1/34, bits rate 3.8 Kbps per channel.

11 kHz: compression ratio 1/34, bits rate 5.2 Kbps per channel.

By default, for the music, with a 50% partial overlap, they choose the base-2 corrected scale, they choose for the forward plan 22 points per frame, the precision of magnitudes on 6 bits and the absolute coding of positions on 10 bits; they choose 54 bands per frame for the backward plan, the precision of magnitudes on 2 bits of average (simple decimation followed by the ADPCM coding on 3 bits). Phases are encoded on 8 bits for the forward plan and on 1 bit of sign for the backward plan.

These parameters give a good quality with the following results:

44 kHz: compression ratio 1/11, bits rate 63.7 Kbps per channel.

If they choose 16 points for the forward plan and 54 bands, the precision of magnitudes on 1.5 bit of average (simple decimation followed by the ADPCM coding on 2 bits), they have the following results:

44 kHz: compression ratio 1/14, bits rate 48.2 Kbps per channel.

If they choose 32 points for the forward plan, the precision of magnitudes on 8 bits, 54 bands for the backward plan and ADPCM on 3 bits without decimation, they have the following results:

44 kHz: compression ratio 1/7, bits rate 95.4 Kbps per channel.

As comparison, with these last values (32 points for the forward plan, the precision of magnitudes on 8 bits, 54 bands for the backward plan and ADPCM on 3 bits without decimation), they have the following results with a 7% partial overlap:

44 kHz: compression ratio 1/10, bits rate 71.1 Kbps per channel.

The partial overlap with less than 50% of overlapping allows to have more higher compression ratios while having fewer computations. They can so offer the below default values, optimized both in term of compression ratios and computations.

Sampling rate: 44 kHz.

Rate of overlap: 7%.

Phases: 8 bits for the forward plan, 1 bit of sign for the backward plan.

Backward plan: 3 bits ADPCM, 64 bands (no computations of energies, no sorting, no positions of bands to transmit).

Music at 48 Kbps per channel:

Forward plan: 22 points, absolute positions on 9 bits, precision of magnitudes on 6 bits.

Backward plan: simple decimation.

44 kHz: compression ratio 1/14, bits rate 48.5 Kbps per channel.

Music at 64 Kbps per channel:

Forward plan: 24 points, absolute positions on 9 bits, precision of magnitudes on 8 bits.

Backward plan: no decimation.

44 kHz: compression ratio 1/11, bits rate 64.5 Kbps per channel.

Music at 96 Kbps per channel:

Forward plan: 58 points, relative positions on 6 bits (there is a big number of points), precision of magnitudes on 8 bits.

Backward plan: no decimation.

44 kHz: compression ratio 1/7, bits rate 95.9 Kbps per channel.

In this practical realization, they set up the following structure for the reading or the data transmission:

General header and forward plan header (1 byte),

Forward plan body (positions, then magnitudes then possible phases),

Backward plan header (0 byte for the voice, 2 bytes for the music),

Bands positions (0 to 8 bytes),

Backward plan body (magnitudes or signed magnitudes).

All important parts of the structure are byte-aligned.

The parameters of the audio and of the codec are read at the beginning of the reading or transmitted at the beginning of the communication.

The points of the forward plan are encoded in the order of decreasing magnitudes with the absolute coding of positions and in the order of increasing positions with the relative coding of positions.

Vectorial compression (not accomplished) can be applied to the backward plan instead of ADPCM compression. Additional compression (not accomplished) without quality loss (lossless compression) can be applied to the forward and the backward plans, to the forward plan only or to the backward plan only.

This codec is intended for all vocal bi-directional communications (voice over IP or mobile phones for instance), for the audio streaming (radios on Internet for instance) as well as for the stocking of audio data (files on hard disk for instance).

What is claimed is:

1) A method of audio compression and decompression comprising
the use of the Fast Fourier Transform (FFT) for the voice and the music and
a decomposition in two plans based on the energy.

2) The method of audio compression and decompression of claim 1, wherein said every frame is split into a forward plan composed of the N biggest points and a backward plan composed of the M most energetic bands.

3) The method of audio compression and decompression of claim 1 or 2, wherein said for the voice, one uses only the magnitudes of the local peaks (without the lateral points) and only the imaginary part in decompression.

4) The method of audio compression and decompression of claim 1 or 2, wherein said for the edge effects canceling with the music, one uses a method of partial overlap allowing a perfect reconstruction, with 50% or less than 50% of overlapping.

5) The method of audio compression and decompression of claim 1, 2 or 3 wherein said to reduce the size of data in the backward bands, one can apply the Adaptive Differential Pulse Code Modulation (ADPCM).

6) The method of audio compression and decompression of claim 1, 2 or 3, wherein said to reduce the size of data in the backward bands, one can apply the simple decimation which leads to a light quality loss, or the double decimation which leads to a bigger quality loss.

7) The method of audio compression and decompression of claim 1 or 2, wherein said for the backward plan, one can apply a coefficient of reduction between 1 and 2 to reduce the size of bands.

8) The method of audio compression and decompression of claim 1, wherein said the frame size (the FFT buffer size) depends on the sampling rate.

9) The method of audio compression and decompression of claim 1, 2 or 3, wherein said two methods of coding of magnitudes are presented: base-10 logarithm and base-2 corrected scale which allows to obtain a great precision.

10) The method of audio compression and decompression of claim 1, 2 or 3, wherein said to diminish the number of bits in the coding of positions, one can use the relative coding.
